(19) United States
(12) Patent Application Publication
(10) Pub. No.: US 2026/0367006 A1
(43) Pub. Date: Nov. 19, 2026

(54) PLASMONIC NANOFRAME NETWORK PARTICLES, METHOD OF MANUFACTURING THE SAME AND THE USE THEREOF

(71) Applicants: UIF(UNIVERSITY INDUSTRY FOUNDATION), YONSEI UNIVERSITY, Seoul (KR); Research & Business Foundation SUNGKYUNKWAN UNIVERSITY, Suwon-si (KR)

(72) Inventors: Sungho PARK, Seongnam-si (KR); Sungwoo LEE, Seoul (KR)

(73) Assignees: UIF(UNIVERSITY INDUSTRY FOUNDATION), YONSEI UNIVERSITY, Seoul (KR); Research & Business Foundation SUNGKYUNKWAN UNIVERSITY, Suwon-si (KR)

(21) Appl. No.: 19/567,132

(22) Filed: Mar. 14, 2026

(30) Foreign Application Priority Data
Mar. 14, 2025 (KR) 10-2025-0033313

(51) Int. Cl. G01N 21/65

(52) U.S. Cl. CPC G01N 21/658

(57) ABSTRACT

The present invention relates to plasmonic nanoframe network particles, a method for producing the same, and uses thereof, wherein the method for producing the plasmonic nanoframe network particles can optimize the near-field focusing capability of the plasmonic nanoframe network particles by forming narrow internal nanogaps by finely adjusting the porosity through a continuous reaction of simultaneously performing platinum deposition and gold (Au) etching through a gold precursor in a one-pot process.

### CROSS-REFERENCE TO RELATED APPLICATION

This application is based on and claims priority under 35 U.S.C. § 119 to Korean Patent Application No. 10-2025-0033313 filed on Mar. 14, 2025, in the Korean Intellectual Property Office, the disclosure of which is incorporated by reference herein in its entirety.

### BACKGROUND

The present invention provides plasmonic nanoframe network particles, a method of manufacturing the same, and the use of the same.

Surface-Enhanced Raman Scattering (SERS) is a high-sensitivity and high-selectivity analytical technique capable of detecting chemical species adsorbed on the surface of noble metal nanoparticles (NPs) at trace levels. The excellent detection performance of SERS is attributed to two major enhancement mechanisms: Electromagnetic Enhancement (EM) and Chemical Enhancement (CM).

Electromagnetic Enhancement (EM) refers to the phenomenon in which electromagnetic near-field enhancement occurs on the surface of plasmonic NPs due to the excitation of localized surface plasmon resonance. In particular, this enhancement effect is greatly increased in intraparticle nanogaps within the plasmon nanoparticles, and these regions are known as hot-spots. Since plasmonic nanogaps are very important in increasing the sensitivity and quantification of SERS analysis, research is actively being conducted to form precise nanogaps within a single plasmonic structure.

By utilizing various chemical properties of Au and Ag, several synthetic methods to transform simple plasmonic nanoparticles (e.g., nanorods, nanostars, nanocubes) into nanoparticles containing complex multiple nanogap structures have been extensively studied.

In addition, in order to enhance the Chemical Enhancement (CM) effect of SERS, the process in which analytes are adsorbed in hot zones within plasmonic nanogaps is very important. Chemical enhancement involves charge transfer between the metal surface and adsorbed molecules, and to maximize this, non-noble metals with strong binding affinity to specific chemical functional groups have been utilized in SERS analysis. For example, copper (Cu) can form strong bonds with carboxylic acids, and aluminum (Al) can form strong bonds with phosphates.

### PRIOR ART DOCUMENTS

### Non-Patent Documents

(Non-Patent Document 1) Chem. Mater. 2015, 27, 7827-7834 (published on Nov. 2, 2015)

### SUMMARY OF THE INVENTION

An object of the present invention is to provide plasmonic nanoframe network particles that form plasmonic internal nanogaps through a tandem reaction, a method manufacturing the same, and the use of the same.

To achieve the above object, the present invention provides plasmonic nanoframe network particles comprising: a rim portion having a closed-loop structure defining an internal region and having a surface coated with gold (Au); and a plurality of branch portions protruding from the rim portion toward the internal region and having surfaces coated with gold (Au), wherein a linear nanogap is formed between adjacent first and second branch portions among the branch portions.

In addition, the present invention provides a method of manufacturing plasmonic nanoframe network particles, comprising: a first step of mixing and reacting gold nanoplates, a first silver precursor, a first platinum precursor, and a first reducing agent in a solvent containing iodide ions to form platinum frame network particles having a platinum rim portion with a closed-loop structure corresponding to the rim of the gold nanoplates and a plurality of platinum branch portions protruding inward from the platinum rim portion; and a second step of coating gold (Au) on the surface of the platinum frame network particles.

In addition, the present invention provides a substrate for surface-enhanced Raman scattering, comprising: a substrate; and the plasmonic nanoframe network particles arranged on the substrate.

In addition, the present invention provides a gas detection method using the substrate for surface-enhanced Raman scattering.

In addition, the present invention provides a virus detection method using the substrate for surface-enhanced Raman scattering.

The method for manufacturing plasmonic nanoframe network particles according to the present invention can optimize the near-field focusing capability of the plasmonic nanoframe network particles by forming narrow internal nanogaps through finely controlling the porosity through a continuous reaction that simultaneously performs platinum deposition and gold (Au) etching through a gold precursor in a one-pot process.

### BRIEF DESCRIPTION OF THE DRAWINGS

FIG. 1 is a schematic image illustrating the method of manufacturing plasmonic nanoframe network particles according to an embodiment of the present invention.

FIG. 2 is an experimental result confirming the morphology of plasmonic nanoframe network particles according to an embodiment of the present invention, showing field emission scanning electron microscopy (FE-SEM), transmission electron microscopy (TEM), and energy dispersive spectroscopy (EDS) images, and a graph showing the porosity of the internal region.

FIG. 3 is a result confirming the plasmonic properties of plasmonic nanoframe network particles according to an embodiment of the present invention, showing analysis results using a UV-Vis-NIR spectrophotometer, dark-field scattering image, and spSERS spectrum.

FIG. 4 is a result confirming the usability of plasmonic nanoframe network particles according to an embodiment of the present invention as a SERS-based sensor.

### DETAILED DESCRIPTION OF THE INVENTION

Hereinafter, embodiments of the present invention will be described in detail with reference to the attached drawings. The present invention may be modified in various ways and may have various forms, and specific embodiments will be illustrated in the drawings and described in detail in the text. However, this is not intended to limit the present invention to specific disclosed forms, and should be understood to include all modifications, equivalents, and substitutes included in the spirit and technical scope of the present invention. Similar reference numerals have been used for similar components while describing each drawing. In the attached drawings, the dimensions of the structures are enlarged from the actual dimensions to ensure clarity of the present invention.

Terms such as first, second, etc. may be used to describe various components, but the components should not be limited by the terms. The terms are used only for the purpose of distinguishing one component from another. For example, a first component may be referred to as a second component without departing from the scope of the present invention, and similarly, a second component may also be referred to as a first component.

The terms used in this application are only used to describe specific embodiments and are not intended to limit the present invention. Singular expressions include plural expressions unless the context clearly indicates otherwise. In this application, terms such as “comprise” or “have” are intended to designate the presence of features, numbers, steps, operations, components, parts, or combinations thereof described in the specification, and should be understood as not excluding in advance the possibility of the presence or addition of one or more other features, numbers, steps, operations, components, parts, or combinations thereof.

Meanwhile, unless defined otherwise, all terms used herein, including technical or scientific terms, have the same meaning as commonly understood by one of ordinary skill in the art to which the present invention belongs. Terms such as those defined in commonly used dictionaries should be interpreted as having a meaning consistent with the meaning in the context of the related art, and unless explicitly defined in this application, should not be interpreted in an ideal or overly formal sense.

The plasmonic nanoframe network particles according to the present invention may comprise: a rim portion having a closed-loop structure defining an internal region and having a surface coated with gold (Au); and a plurality of branch portions protruding from the rim portion toward the internal region and having surfaces coated with gold (Au), wherein a linear nanogap may be formed between adjacent first and second branch portions among the branch portions.

The rim portion may be in one or more forms selected from the group consisting of circular, triangular, and hexagonal. Specifically, the rim portion may be in the form of triangular.

The length or diameter of one side of the rim portion may be about 50 to 500 nm, about 70 to 400 nm, or about 100 to 300 nm.

The thickness of the rim portion may be about 20 to 50 nm or about 25 to 35 nm.

The porosity of the internal region may be about 1 to 15%, about 1 to 10%, or about 1 to 5%. By having such porosity, narrow internal nanogaps can be formed to optimize the near-field focusing capability of the plasmonic nanoframe network particles.

The width of the linear nanogap may be greater than 0 and 1.5 nm or less, or greater than 0 and 1 nm or less.

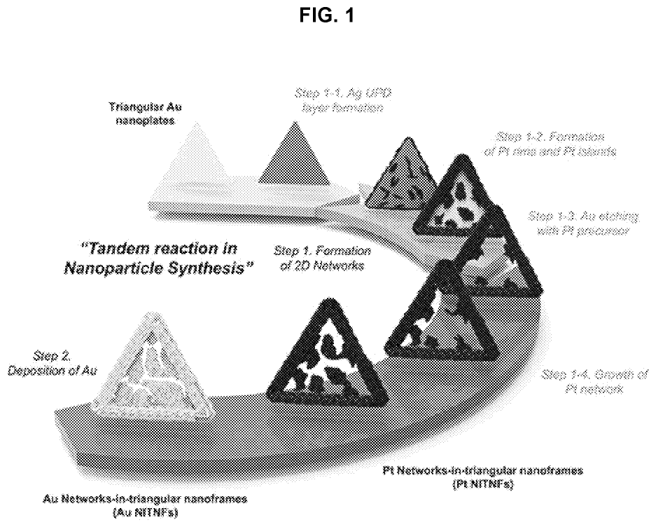

FIG. 1 is a schematic image illustrating the manufacturing method of plasmonic nanoframe network particles according to the present invention.

Referring to FIG. 1, the method of the plasmonic nanoframe network particles according to the present invention may comprise: a first step of mixing and reacting gold nanoplates, a first silver precursor, a first platinum precursor, and a first reducing agent in a solvent containing iodide ions to form platinum frame network particles having a platinum rim portion with a closed-loop structure corresponding to the rim of the gold nanoplates and a plurality of platinum branch portions protruding inward from the platinum rim portion; and a second step of coating gold (Au) on the surface of the platinum frame network particles.

Using triangular gold (Au) nanoplates (TANs) as a starting template, platinum nanoparticle networks (Pt NITNFs) were synthesized through a continuous reaction without the need to separate intermediates within a single reaction vessel. This process may include a step 1-1 of forming a silver (Ag) underpotential deposition (UPD) layer, a step 1-2 of forming Pt rims and Pt islands, a step 1-3 of selectively etching Au using a Pt precursor, a step 1-4 of controlling internal void space through Pt network growth, and a second step of depositing Au on Pt NITNFs to impart plasmonic properties.

The first step is characterized in that the platinum precursor simultaneously serves as a raw material for forming platinum frame network particles and an etchant for etching the gold (Au) nanoplates.

In the first step, the reaction may be performed at about 50 to 100 °C or about 60 to 80 °C for about 10 to 20 hours or about 10 to 15 hours.

The concentration of the first silver precursor may be about 0.5 to 10 μM, about 1 to 8 μM, or about 1 to 5 μM, and the concentration of the first platinum precursor may be about 15 to 40 μM, about 20 to 40 μM, or about 20 to 30 μM.

In the first step, when the mixed solution includes a plurality of gold nanoplates, the mixed solution may further include a surfactant. The surfactant may include at least one selected from the group consisting of hexadecyltrimethylammonium bromide (CTAB), hexadecyltrimethylammonium chloride (CTAC), tetradecyltrimethylammonium bromide (TTAB), polyvinylpyrrolidone (PVP), polyethylene glycol (PEG), poly(diallyldimethylammonium chloride) (PDDA), Tween 20, oleylamine, and sodium dodecyl sulfate (SDS).

Specifically, the first step may include: a step 1-1 of forming a silver (Ag) underpotential deposition (UPD) layer; a step 1-2 of forming a platinum (Pt) rim portion and platinum branch portions; a step 1-3 of selectively etching gold (Au) using a platinum precursor; and a step 1-4 of controlling the porosity of the internal region through growth of the platinum branch portions.

In the step 1-1, the silver precursor may be reduced on the surface of the gold nanoplates (TANs) to form a silver underpotential deposition (Ag UPD) layer. Formation of the silver underpotential deposition layer may be promoted by effective adsorption of iodide ions (I⁻) on the (111) plane of the gold nanoplates, which may be due to the strong affinity of the iodide ions (I⁻) for silver ions (Ag⁺) (KSP(AgI)=8.3×10−17). After forming AgI, the silver ions (Ag⁺) may be reduced on the surface of the gold nanoplates by a mild reducing agent. The reaction of the step 1-1 may be performed for a period of 1 hour or less.

In the step 1-2, platinum may be deposited on the gold nanoplates through a galvanic replacement reaction with the silver underpotential deposition layer. The silver underpotential deposition layer may be oxidized by the platinum precursor while serving as an electron shuttle, and may be repeatedly reduced by an oxidizing agent. For example, the platinum precursor may be rapidly reduced at the sharply formed edge and vertex regions of the gold nanoplates (high-energy surfaces; CNedge≈8, CNvertex≈6), thereby exhibiting a fast growth rate, whereas the platinum precursor may be relatively slowly reduced at the flat terrace regions of the gold nanoplates (low-energy surfaces; CNterrace≈9) thereby exhibiting a slow growth rate. Due to such differences in deposition rate depending on the region, a thick platinum rim may be formed at the peripheral portion of the gold nanoplates, and Pt islands may randomly grow at high-energy zigzag elbow regions of the terrace according to a Volmer-Weber growth mode, which may be due to a large lattice mismatch between Au (lattice constant=0.4065 nm) and Pt (lattice constant=0.3912 nm). The reaction of the step 1-2 may be performed for about 2 hours to about 3 hours.

In the step 1-3, as the silver underpotential deposition layer is oxidized, the exposed (111) surface of the gold nanoplates may be oxidized simultaneously with reduction of the platinum precursor (E°[Au/AuI4−]=0.56 V, E°[Pt/PtCl62−]=0.74 V), and this process may be promoted by I⁻ ionsr (E°[Au/AuI4−]=0.56 V, E°[Pt/PtCl62−]=0.74 V), and this process may be promoted by I⁻ ions strongly adsorbed on the (111) terrace regions. For example, the I⁻ ions may lower the standard reduction potential of Au, thereby enabling a redox reaction with the Pt precursor. The reaction of the step 1-3 may be performed for about 5 hours to about 6 hours.

In the step 1-4, as gold is oxidized, platinum islands located adjacent to the platinum rim may continue to grow and expand, and may eventually fuse with the platinum rim to form platinum branches protruding from platinum nanoparticles. In addition, isolated platinum islands on the terrace regions may be separated from the platinum rim and remain as platinum debris (Pt debris). Thereafter, additional platinum may be deposited on the platinum branches, thereby forming a platinum nanoframe network. The reaction of the step 1-4 may be performed for about 2 hours to about 3 hours.

In the second step, the platinum frame network particles, a second silver precursor, a second platinum precursor, and a second reducing agent may be mixed and reacted at about 10 to 50 °C or about 20 to 40 °C for about 5 minutes to 30 minutes or about 10 minutes to 20 minutes.

The concentration of the second silver precursor may be about 0.8 to 1.5 mM or about 1.0 to 1.2 mM, and the concentration of the second platinum precursor may be about 0.8 to 1.5 mM or about 1.0 to 1.2 mM. The concentration of the reducing agent may be about 4.0 to 5.5 mM or about 5.0 to 5.5 mM.

In the second step, when the mixed solution includes a plurality of platinum nanoframe networks, the mixed solution may further include a surfactant. The surfactant may include at least one selected from the group consisting of hexadecyltrimethylammonium bromide (CTAB), hexadecyltrimethylammonium chloride (CTAC), tetradecyltrimethylammonium bromide (TTAB), polyvinylpyrrolidone (PVP), polyethylene glycol (PEG), poly(diallyldimethylammonium chloride) (PDDA), Tween 20, oleylamine, and sodium dodecyl sulfate (SDS).

In the second step, gold may be reduced on the platinum nanoframe network to impart plasmonic properties. After forming a silver underpotential deposition layer on the rough surface of the platinum nanoframe network, gold may be uniformly deposited through Frank-van der Merwe growth, thereby forming a finely tuned narrow nanogap while maintaining an internal empty space. In the prepared gold nanoframe network particles, the internal porosity may be reduced to about 1 to 5%, such that a nanogap of greater than 0 and not greater than 1.5 nm may be formed, thereby improving near-field focusing capabilities.

The first and second silver precursors may independently include one or more selected from the group consisting of silver nitrate (AgNO3), silver acetate (AgC2H3O2), silver lactate (AgC3H5O3), silver citrate (Ag3C6H5O7), silver oxalate (Ag2C2O4), silver carbonate (Ag2CO3), and silver sulfate (Ag2SO4).

The first and second platinum precursors may independently include one or more selected from the group consisting of hexachloroplatinic(IV) acid (H2PtCl6), platinum(IV) chloride (PtCl4), platinum(II) chloride (PtCl2), tetrachloroplatinic(II) acid (H2PtCl4), platinum(IV) nitrate (Pt(NO3)4), platinum(II) acetate (Pt(C2H3O2)2), and platinum(II) oxalate (PtC2O4).

The first and second reducing agents may independently include one or more selected from the group consisting of ascorbic acid, citric acid, glucose, sorbitol, disodium tartrate, and hydrazine.

In addition, the present invention provides a substrate for surface-enhanced Raman scattering, comprising: a substrate; and a plasmonic nanoframe network particles arranged on the substrate.

Since the description of the plasmonic nanoframe network particles is the same as described above, a redundant detailed description thereof will be omitted.

The substrate may include one or more selected from the group consisting of aluminum, nickel, copper, and iron. By using such a substrate, gas molecules can be effectively captured in hot zones of the plasmonic structure.

In the substrate for surface-enhanced Raman scattering, a plurality of plasmonic nanoframe network particles may be arranged on the substrate to form a superlattice.

In addition, the present invention provides a gas detection method using the substrate for surface-enhanced Raman scattering.

Since the description of the substrate for surface-enhanced Raman scattering is the same as described above, a redundant detailed description thereof will be omitted.

The gas detection method according to the present invention may include: exposing the substrate for surface-enhanced Raman scattering to a gas such that the gas binds to a surface of the substrate; and analyzing the substrate to which the gas is bound using a Raman spectrometer.

In addition, the present invention provides a virus detection method using the substrate for surface-enhanced Raman scattering.

Since the description of the substrate for surface-enhanced Raman scattering is the same as described above, a redundant detailed description thereof will be omitted.

Hereinafter, the present invention will be described in detail with reference to examples and the like to facilitate understanding of the present invention. However, the following examples and the like are merely illustrative of the contents of the present invention, and the scope of the present invention is not limited to the following examples and the like. The examples and the like of the present invention are provided to more completely describe the present invention to those having average knowledge in the art.

### [Preparation Example 1] Synthesis of Triangular Platinum Nanoframe Networks (Pt NITNFs)

To synthesize Pt NITNFs, 8 mL of triangular gold (Au) nanoplate (TAN) solution was added to a mixture containing 30 mL of 0.05 M CTAB, 50 μL of 2 mM AgNO3, 960 μL of 0.1 M ascorbic acid, 960 μL of 0.1 M hydrochloric acid (HCl), and 500 μL of 2 mM hexachloroplatinic acid (H2PtCl6) solution with 50 μM of iodide ions. After this reaction was conducted at 70 °C for 12 hours, it was washed twice with triply deionized water through centrifugation (8,000 rpm, 10 minutes).

For large-scale synthesis, 240 mL of TAN solution was added to a mixture containing 150 mL of 0.05 M CTAB, 600 μL of 2 mM AgNO3, 9.6 mL of 0.1 M ascorbic acid, 9.6 mL of 0.1 M hydrochloric acid, and 6 mL of 2 mM H2PtCl6 solution with 50 μM of iodide. Thereafter, after the reaction was conducted at 70 °C for 12 hours, the final solution was obtained by washing twice in the same manner (centrifugation 8,000 rpm, 10 minutes).

### [Example 1] Synthesis of Gold Nanoframe Networks (Au NITNFs) Particles

To synthesize Au NITNFs, 10 mL of Pt NITNF (Preparation Example 1) solution was mixed with 8 mL of 0.2 M CTAC, 160 μL of 20 mM AgNO3, 160 μL of 0.1 M ascorbic acid, and 160 μL of 20 mM HAuCl4 solution. After this reaction was conducted at 30 °C for 15 minutes, it was washed twice with triply deionized water through centrifugation (4,000 rpm, 10 minutes).

For large-scale synthesis, 240 mL of Pt NITNF solution was added to a mixture containing 240 mL of 0.2 M CTAC, 1 mL of 20 mM AgNO3, 1 mL of 0.1 M ascorbic acid, and 1 mL of 20 mM HAuCl4 solution. Thereafter, after the reaction was conducted at 70 °C for 1 hour, the final solution was obtained by washing twice in the same manner (centrifugation 4,000 rpm, 10 minutes).

### [Example 2] Fabrication of 2D Nanoparticle Superlattice on Al Foil

A SERS substrate for detecting gas-phase dimethyl methylphosphonate (DMMP) was fabricated on Al foil using a rapid solvent evaporation-based nanoparticle assembly process. First, to purify the surface of the Al foil, electropolishing was performed in 20% perchloric acid (diluted in ethanol) at 20 V for 1 minute. During the electropolishing process, the temperature was maintained at 0 °C using a circulating water system. After completion of the reaction, the Al foil was thoroughly washed with triply deionized water to remove remaining perchloric acid.

Next, 100 μL of 0.5 mg/mL mPEG (dissolved in deionized water) was mixed with 10 mL of the nanoparticle solution prepared in Example 1, and reacted at 70 °C for 12 hours. After the reaction was completed, it was washed with triply deionized water through centrifugation (8,000 rpm, 10 minutes). Thereafter, polystyrene thiol was added to decorate the nanoparticle surface with heterogeneous dual ligands to promote interfacial assembly between hydrophobic and hydrophilic solvents. To this end, 50 μL of 3 mg/mL polystyrene thiol (dissolved in THF) was added to the nanoparticle solution coated with mPEG, and then reacted at 70 °C for 12 hours. After completion of the reaction, it was washed three times with DMF through centrifugation (8,000 rpm, 10 minutes).

The nanoparticle solution coated with mPEG and polystyrene thiol was centrifuged to replace the solvent from DMF to toluene. Thereafter, the Al foil was placed on a hot plate, and 5 μL of diethylene glycol was dropped onto the Al foil. After heating the foil to 70 °C, 10 μL of the nanoparticle solution decorated with mPEG and polystyrene thiol dispersed in toluene was dropped onto the surface of the diethylene glycol. The toluene was completely evaporated by heating at 70 °C for 30 minutes. Thereafter, the substrate was placed in a 70 °C oven to evaporate the diethylene glycol and anneal the nanoparticles. Finally, the Al foil on which the 2D nanoparticle superlattice was formed was washed with ethanol, and then O2 plasma treatment was performed to remove mPEG and polystyrene thiol for SERS measurement.

### Experimental Method

### Single Particle SERS (spSERS) Measurement

To perform spSERS measurement by saturating the nanoparticle surface with an analyte, 5 μL of 10-2 M 2-NTT solution was added to 1 mL of nanoparticle solution. After 3 hours, the nanoparticles were washed twice with triply deionized water through centrifugation (10,000 rpm, 5 minutes). Thereafter, the nanoparticle solution decorated with the analyte was dropped onto a Si wafer and then dried using N2 gas. The position of each particle was monitored using a dark-field scattering microscope. The spSERS spectrum of 2-NTT was measured using an integration time of 10 seconds, a laser excitation wavelength of 785 nm, a laser output of 4 mW, and a 100× objective lens.

### 2) In Situ SERS Detection of Gas-Phase DMMP

For in situ SERS detection of gas-phase DMMP using a 2D nanoparticle superlattice, a calibration gas generator (Dynacalibrator Model 230, VICI Valco Instruments) was used to control the concentration and flow rate of gas molecules. Gas molecules were released from 1 mL of liquid DMMP in a permeation tube sealed with a Teflon bar, and mixed with filtered clean air (diluent gas) to lower the DMMP concentration. This gas mixture was continuously generated and supplied to the SERS substrate, maintaining a constant concentration of calibration gas flow.

The SERS substrate was placed inside a chamber covered with glass on the top, and the inlet of the chamber was connected to the calibration gas generator and the outlet was connected to a fume hood to remove residual DMMP gas. The concentration of gas molecules was controlled by adjusting the temperature and the number of permeation tubes, and the flow rate was controlled by adjusting the diluent gas flow.

SERS spectra were acquired using an integration time of 5 seconds, a laser excitation wavelength of 785 nm, a laser output of 4 mW, and a 20× objective lens.

### Experimental Example 1

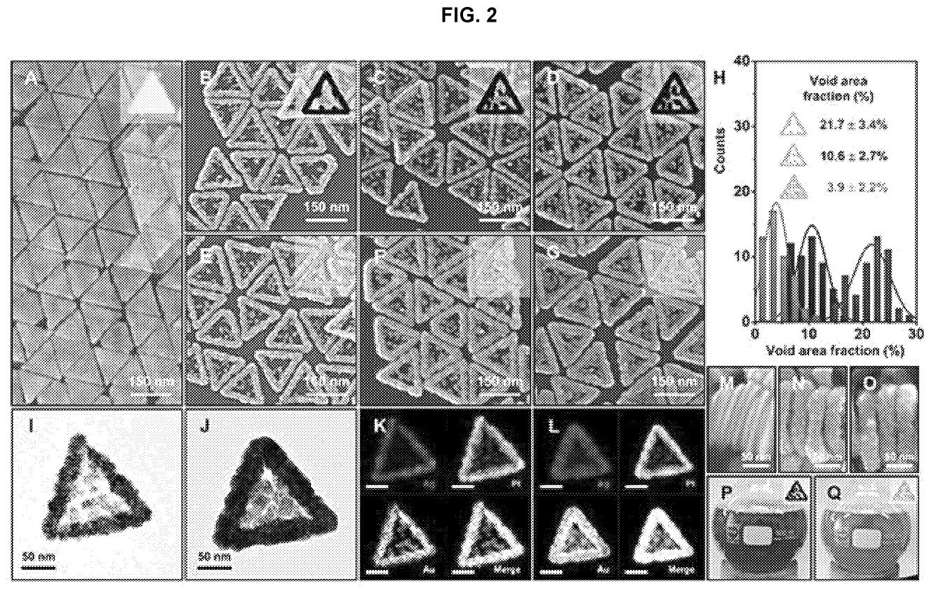

To confirm the morphology of the plasmonic nanoframe network particles according to the present invention, they were photographed with a field emission scanning electron microscope (FE-SEM) and a transmission electron microscope (TEM), and the results are shown in FIG. 2.

FIG. 2 is an image showing the size and shape of triangular Au nanoplates (TANs), Pt NITNFs, and Au NITNFs analyzed using a field emission scanning electron microscope (FE-SEM) and a transmission electron microscope (TEM). Starting from TANs having sharply formed edges and vertices as well as flat terrace surfaces (FIG. 2A), Pt NITNFs in which a Pt network was distinctly formed within a triangular Pt nanoparticle structure were synthesized (FIG. 2B-D). To control the internal void ratio, the total reaction time of the continuous reaction process was varied to 9 hours, 10 hours, and 12 hours. In a control experiment, the concentrations of Ag and Pt precursors were optimized so that Pt NITNFs were successfully formed during the continuous reaction. When the Ag precursor concentration was set to 0.25 μM, triangular Au@Pt core-shell nanoplates were formed. This was due to incomplete formation of the Ag UPD layer. On the other hand, when the Ag precursor concentration was set to 25 μM, a thick and stable Ag UPD layer was formed. This thick layer enabled selective deposition of Pt along the periphery of TANs, but prevented exposure of the Au (111) terrace surface of TANs, thereby hindering the etching of Au by the Pt precursor, and as a result, TANs in which a Pt rim selectively decorated the periphery were formed.

When the Pt precursor concentration was set to 2.5 μM, a thin Pt rim was formed along the vertices and edges as Pt was selectively deposited along the periphery of TANs. However, as the Pt precursor was depleted during deposition, oxidation of Au was inhibited, and the formation of a Pt network with an internal void structure was not achieved. The optimal concentrations of Ag and Pt precursors for successfully synthesizing Pt NITNFs in which the Pt network structure was clearly formed were 2.5 μM and 25 μM, respectively.

Thereafter, Au was uniformly deposited on the Pt NITNFs to prepare Au NITNFs having different internal void ratios. To this end, the concentrations of Au3+ ions (0.8, 1.0, 1.1 mM), ascorbic acid (4.0, 5.0, 5.5 mM), and Ag+ ions (0.8, 1.0, 1.1 mM) were adjusted (FIG. 2E-G). As a result of measuring the average internal void area of Au NITNFs using the ImageJ program, the internal void area ratios of Au NITNFs shown in FIG. 2E to G were estimated to be 21.7±3.4%, 10.6±2.7%, and 3.9±2.2%, respectively (FIG. 2H).

As a result of HR-TEM analysis, when looking at (I) of FIG. 2, it was found that the rough Pt network surface was formed by aggregation of a plurality of Pt particles. When looking at (J) of FIG. 2, after Au was deposited on Pt NITNFs, uniformly reduced Au species formed a smooth surface while maintaining a narrow nanogap. In addition, the presence of Ag, Au, and Pt elements was confirmed through energy dispersive spectroscopy (EDS) mapping analysis of Pt and Au NITNFs (K and L of FIG. 2). The atomic composition ratio of Au NITNFs was analyzed as Au 54.80%, Pt 28.14%, and Ag 17.06%, which shows that the Au ratio increased and the Pt ratio decreased when compared to the atomic composition ratio of Pt NITNFs (Au 36.24%, Pt 57.47%, Ag 6.29%). In addition, the Ag ratio slightly increased as an Ag UPD layer was introduced to Pt NITNFs in the Au deposition step.

When looking at (M) and (N) of FIG. 2, after TANs were converted to Pt NITNFs, the thickness increased from 9±1 nm to 27±3 nm, and when looking at (O) of FIG. 2, thereafter, as Au was deposited, the thickness slightly increased to 31±3 nm while maintaining the internal nanogap within the particles.

When looking at (P) and (Q) of FIG. 2, the series of continuous reaction processes of converting TANs to Pt NITNFs and finally to Au NITNFs showed high efficiency, and through this, synthesis on a scale of 480 mL was possible. As a result of inductively coupled plasma (ICP) analysis, the concentration of Au NITNFs was measured as 130 mg/mL. It was confirmed that this continuous reaction process can also be applied to circular and hexagonal Au nanoplates. In order for Au nanoplates to be oxidized by the Pt precursor for internal void formation, it is essential to maintain the thickness of the nanoplates at about 24 nm or less.

### Experimental Example 2

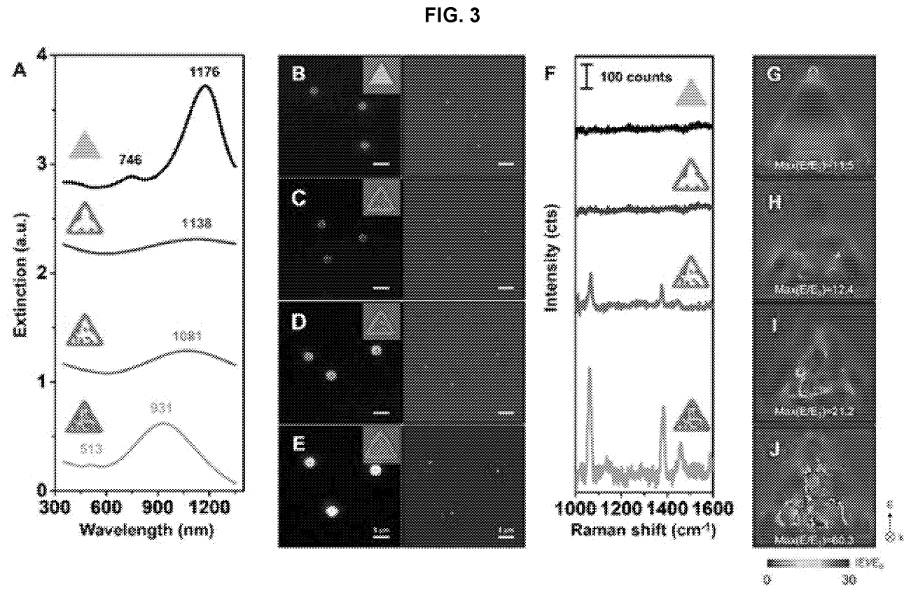

To confirm the plasmonic properties of the plasmonic nanoframe network particles according to an embodiment of the present invention, analysis was performed using a UV-Vis-NIR spectrophotometer, dark-field scattering image, and spSERS spectrum, and the results are shown in FIG. 3.

The plasmonic properties of various nanoparticles (including TANs and Au NITNFs) were analyzed using a UV-vis-NIR spectrophotometer, and the results are shown in FIG. 3A. TANs exhibited in-plane quadrupole and dipole modes at 746 nm and 1176 nm, respectively, which is a representative characteristic of anisotropic nanoplates forming a plasmonic band in the near-infrared (NIR) region (black spectrum). On the other hand, Pt NITNFs showed a broad spectrum without distinct features in the measured wavelength range because the plasmonic activity is low in the visible and NIR regions.

After depositing Au on Pt NITNFs, a plasmonic band was formed in the NIR region. As the internal void ratio decreased from 21.7±3.4% to 10.6±2.7% and 3.9±2.2%, the in-plane dipole mode was blueshifted from 1138 nm to 1081 nm and 931 nm, and the peak intensity also increased. This phenomenon is commonly observed in hollow nanostructures. Narrow internal nanogaps (hotspots) within the plasmonic nanostructure serve to effectively focus the electromagnetic near-field and greatly enhance the surface-enhanced Raman spectroscopy (SERS) signal.

Single particle SERS (spSERS) measurement was performed to evaluate the near-field focusing ability of nanoparticles (FIG. 3B to F). The surface of Au NITNFs was modified with 2-naphthalenethiol (2-NTT) and then randomly dispersed on a Si wafer. After monitoring the position of nanoparticles on the Si wafer using a dark-field scattering image, spSERS measurement was performed, and it was confirmed through FE-SEM analysis that the measured SERS signal was generated from a single nanoparticle.

In addition, finite element method (FEM) simulation was performed using COMSOL Multiphysics software to theoretically analyze the near-field focusing ability of the nanostructures (FIG. 3G-J). In the theoretical simulation, a model was constructed by mimicking the structure of Au NITNFs observed in FE-SEM images.

TANs showed weak near-field focusing ability, so the spSERS signal hardly appeared. In addition, when the TAN surface was modified with 2-NTT, the tip portion that was easily oxidized tended to become rounded, which indicates that the anisotropic nanostructure is unstable. Au NITNFs with an internal void ratio of 21.7±3.4% did not show spSERS signals because the internal nanogap distance was too large to effectively focus the electromagnetic near-field. However, when the internal void ratio decreased to 10.6±2.7%, a spSERS signal of 140 counts at 1069 cm−1 appeared clearly, showing the near-field focusing ability through the narrow nanogap.

When the internal void ratio was further reduced to 3.9±2.2%, the spSERS signal intensity exponentially increased to 452 counts, indicating that the spSERS signal intensity increases as the nanogap distance decreases. As a result of calculating the enhancement factor (EF) of Au NITNFs, the EF was estimated to be 2.0×108 when the internal void ratio was 10.6±2.7%, and 6.1×108 when it was 3.9±2.2%. Through this, it was confirmed that Au NITNFs have strong light-trapping ability.

As a result of electromagnetic simulation (electromagnetic polarization direction: yz plane), Au NITNFs with an internal void ratio of 3.9±2.2% exhibited the highest electric field amplification value (60.3) among the nanoparticles used in the experiment.

### Experimental Example 3

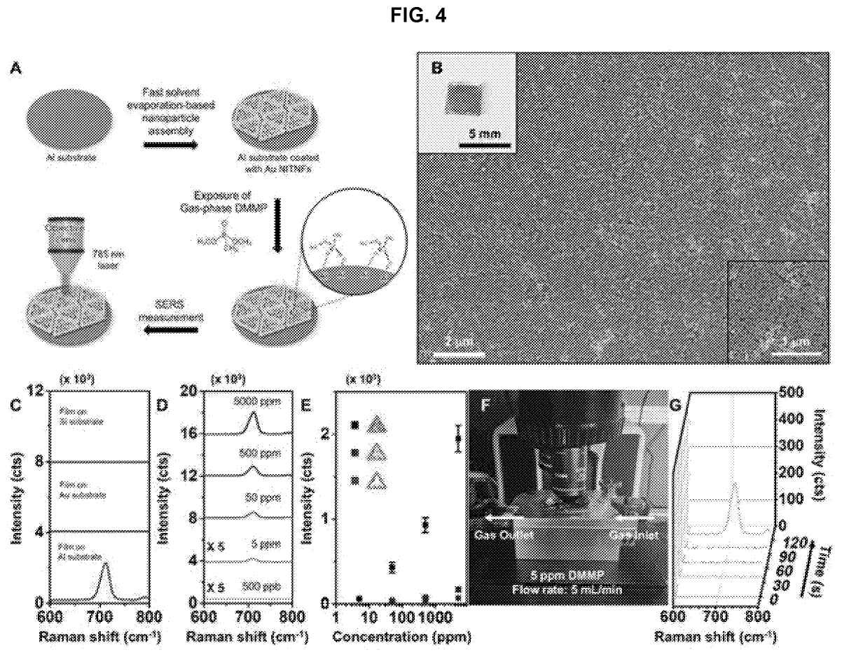

In order to confirm the applicability of the plasmonic nanoframe network particles according to an embodiment of the present invention as a SERS-based sensor, a gas detection experiment was performed, and the results are shown in FIG. 4.

By utilizing the versatility of Au NITNFs, the performance as a SERS substrate for the detection of gaseous chemical warfare agent (CWA) simulants such as DMMP that mimics the nerve agent sarin (GB) was demonstrated. Early detection of such toxic CWAs is very important, but detection using SERS technology is difficult due to low adsorption characteristics on noble metal-based SERS substrates.

To solve this problem, aluminum (Al), which is known to have a strong affinity for phosphate groups, was used to effectively capture gas molecules in the hot zone of the plasmonic nanostructure. Through this, the SERS-based detection performance was improved, and it was confirmed that it can be used as a powerful tool for identifying organic toxic pollutants.

To verify the possibility of detecting gaseous CWA simulants of Au NITNFs, a 2D plasmonic superlattice structure was formed on an Al foil using a rapid solvent evaporation-based nanoparticle assembly process (FIG. 4A). In this process, Au NITNFs were stabilized with heterogeneous dual ligands (polyethylene glycol methyl ether thiol and w-thiol terminated polystyrene), and the assembly proceeded at the interface of hydrophilic (diethylene glycol) and hydrophobic (toluene) solvents.

Subsequently, liquid DMMP was placed at the bottom of a glass bottle, and a 2D Au NITNF superlattice formed on Al foil was attached to the lid. After sealing the bottle, it was heated in an oven to completely vaporize the liquid DMMP. The Au NITNF superlattice on the Al foil was exposed to gaseous DMMP molecules for 10 minutes to induce DMMP binding on the Al foil surface, and then SERS measurement was performed (laser excitation wavelength: 785 nm, laser power: 4 mW).

In the present invention, Au NITNFs with an internal void ratio of 3.9±2.2%, which exhibited the highest near-field focusing capability, were utilized for DMMP detection.

As a result of FE-SEM image analysis, it was confirmed that a densely arranged 2D Au NITNF superlattice was successfully formed on the Al foil (FIG. 4B). The monolayer superlattice had high uniformity and exhibited a long-range periodic arrangement.

In order to evaluate the phosphate binding effect of the Al substrate, 2D Au NITNF superlattices were formed on a Si substrate (Si wafer) and an Au substrate (Au-coated Si wafer). As a result, the 2D Au NITNF superlattice on the Al foil successfully detected a SERS signal including the main characteristic peak of DMMP (710 cm−1, n(P-CH3), n(P-O), d(P-O-CH3) vibration modes) (FIG. 4C).

On the other hand, the 2D Au NITNF superlattices on the Si and Au substrates did not show the SERS signal of DMMP, which indicates low binding affinity between DMMP and the Si or Au surface. Looking at FIGS. 4(D) and (E), as a result of analyzing the SERS signal intensity while varying the DMMP gas concentration, the SERS signal intensity decreased as the DMMP gas concentration decreased, suggesting that the binding between DMMP and the Al foil plays an important role. The detection limit of DMMP was 5 ppm. The Au NITNFs superlattices with internal void ratios of 21.7±3.4% and 10.6±2.7%, respectively, showed higher detection limits than the case of 3.9±2.2% (500 and 50 ppm), and when Au nanospheres, Au nanorods, and triangular Au nanoplates were deposited on Al foil, they showed high sensitivity but low reproducibility. In particular, the triangular Au nanoplates on the Al foil had oxidized tips, resulting in deteriorated DMMP detection performance.

From these results, it can be seen that the narrow internal nanogap plays an important role in stably enhancing the SERS signal.

The reason why the SERS signal of DMMP was clearly detected in the 2D Au NITNF superlattice on the Al foil can be explained by the following three factors: (1) the internal nanogap of Au NITNFs with strong electromagnetic near-field focusing capability, (2) the interparticle nanogap of the 2D superlattice densely arranged on the Al foil, and (3) DMMP molecules effectively adsorbed in the hot zone by the strong affinity between DMMP and the Al foil.

In particular, Au NITNFs with open nanogaps play two important roles: (1) effective near-field focusing in the open nanogap, and (2) inducing DMMP to access the Al foil through the open nanogap. To verify this, a thick coffee ring-shaped Au nanoparticle assembly was intentionally fabricated to block the open nanogap, and then SERS measurement of DMMP was performed. As a result, the SERS signal was not detected because the thick Au nanoparticle layer blocked the Al surface and hindered the adsorption of gaseous DMMP molecules. In addition, the SERS signal of DMMP did not appear on the Al foil without Au NITNFs, indicating that Au NITNFs capable of near-field focusing are essential for DMMP detection.

In such a structure, confined light and reflected light are concentrated in narrow nanogaps, thereby greatly enhancing the electromagnetic near-field. In this study, by combining Au NITNFs with open nanogaps and Al foil to form a trench-like configuration, the Al foil blocked the bottom surface and reflected light, thereby maximizing light utilization efficiency inside the Au NITNFs.

These results emphasize that the electromagnetic (EM) mechanism can operate independently of the chemical (CM) mechanism when the analyte is located near the hot spot. In this detection strategy, since the analyte is immobilized on the Al substrate, it can continuously remain near the Au nanogap. The Al substrate itself is not a SERS-active substrate, but serves as an anchor to immobilize the analyte. Au NITNFs have low affinity for DMMP, but can generate a strong electromagnetic field around the nanogap. Therefore, both Al and Au NITNFs are essential for DMMP detection, and when the analyte is located near the hot spot, the EM mechanism can induce strong SERS enhancement.

To evaluate the applicability of the 2D Au NITNF superlattice on Al foil as a SERS-based CWA detection system, in situ SERS measurement was performed using a calibration gas generator. A permeation tube containing liquid DMMP was heated in the heating chamber of the gas generator to release gaseous DMMP. The DMMP concentration was controlled by adjusting the temperature of the heating chamber, and then the DMMP gas was mixed with the carrier gas to control the flow rate.

As can be seen in FIG. 4(F), the Au NITNF superlattice on the Al foil was fixed inside the chamber where the internal gas concentration (2-10 ppm) and flow rate (1-7 mL/min) were controlled. The top of the chamber was made of transparent glass, enabling in situ SERS measurement while injecting gaseous DMMP (laser excitation wavelength: 785 nm, laser power: 4 mW).

Referring to FIG. 4(G), as a result of the experiment, in the SERS-based gas molecule detection using Au NITNFs on Al foil, the SERS signal was detected within 120 seconds at a DMMP concentration of 5 ppm and a flow rate of 5 mL/min. On the other hand, Au NITNFs with an internal void ratio greater than 3.9% did not detect the SERS signal of DMMP within 120 seconds, which was due to the weak near-field focusing effect.

Therefore, Au NITNFs on Al foil can exhibit excellent sensitivity and selectivity as a SERS-based sensor for DMMP detection.

The foregoing description of the present invention is for illustration, and those of ordinary skill in the art to which the present invention pertains will be able to understand that it can be easily modified into other specific forms without changing the technical spirit or essential features of the present invention. Therefore, the embodiments described above should be understood as illustrative in all respects and not restrictive.

The scope of the present invention is indicated by the claims described below, and all changes or modified forms derived from the meaning and scope of the claims and their equivalent concepts should be construed as being included in the scope of the present invention.

What is claimed is:

1. A plasmonic nanoframe network particle comprising:
a rim portion having a closed-loop structure defining an internal region and having a surface coated with gold (Au); and
a plurality of branch portions protruding from the rim portion toward the internal region and having surfaces coated with gold (Au),
wherein a linear nanogap is formed between adjacent first and second branch portions among the branch portions.

2. The plasmonic nanoframe network particle according to claim 1, wherein the rim portion has a shape selected from the group consisting of a circular shape, a triangular shape, and a hexagonal shape.

3. The plasmonic nanoframe network particle according to claim 1, wherein a porosity of the internal region is 1 to 15%.

4. The plasmonic nanoframe network particle according to claim 1, wherein a width of the linear nanogap is greater than 0 and not greater than 1.5 nm.

5. The plasmonic nanoframe network particle according to claim 1, wherein a thickness of the rim portion is 20 to 50 nm.

6. A method of manufacturing a plasmonic nanoframe network particle comprising:
a first step of mixing and reacting gold nanoplates, a first silver precursor, a first platinum precursor, and a first reducing agent in a solvent containing iodine ions to form platinum frame network particles having a platinum rim portion in a closed-loop structure corresponding to a rim of the gold nanoplates and a plurality of platinum branch portions protruding inward from the platinum rim portion; and
a second step of coating gold (Au) on a surface of the platinum frame network particles.

7. The method according to claim 6, wherein the first step comprises:
a step 1-1 of forming a silver (Ag) underpotential deposition (UPD) layer;
a step 1-2 of forming a platinum (Pt) rim portion and platinum branch portions;
a step 1-3 of selectively etching gold (Au) using a platinum precursor; and
a step 1-4 of controlling the porosity of the internal region through the growth of the platinum branch portions.

8. The method according to claim 7, wherein, in the first step, the platinum precursor simultaneously serves as a raw material for forming the platinum frame network particle and as an etchant for etching gold (Au) nanoplates.

9. The method according to claim 6, wherein the first reducing agent comprises one or more selected from the group consisting of ascorbic acid, citric acid, glucose, sorbitol, disodium tartrate, and hydrazine.

10. The method according to claim 6, wherein the first and second silver precursors independently comprise one or more selected from the group consisting of silver nitrate (AgNO₃), silver acetate (AgC₂H₃O₂), silver lactate (AgC₃H₅O₃), silver citrate (Ag₃C₆H₅O₇), silver oxalate (Ag₂C₂O₄), silver carbonate (Ag₂CO₃), and silver sulfate (Ag₂SO₄).

11. The method according to claim 6, wherein the first and second platinum precursors independently comprise one or more selected from the group consisting of chloroplatinic(IV) acid (H₂PtCl₆), platinum(IV) chloride (PtCl₄), platinum(II) chloride (PtCl₂), chloroplatinous(II) acid (H₂PtCl₄), platinum(IV) nitrate (Pt(NO₃)₄), platinum(II) acetate (Pt(C₂H₃O₂)₂), and platinum(II) oxalate (PtC₂O₄).

12. The method according to claim 6, wherein the reaction of the first step is performed at 50 to 100 °C for 10 to 20 hours.

13. The method according to claim 6, wherein a concentration of the first silver precursor is 0.5 to 10 μM, and a concentration of the first platinum precursor is 15 to 40 μM.

14. The method according to claim 6, wherein, in the second step, the platinum frame network particle, a second silver precursor, a second platinum precursor, and a second reducing agent are mixed and reacted at 10 to 50 °C for 5 minutes to 30 minutes.

15. The method according to claim 14, wherein a concentration of the second silver precursor is 0.8 to 1.5 mM, and a concentration of the second platinum precursor is 0.8 to 1.5 mM.

16. The method according to claim 6, wherein when the mixed solution in the first step comprises a plurality of gold nanoplates, the mixed solution further comprises a surfactant, and
the surfactant comprises one or more selected from the group consisting of hexadecyltrimethylammonium bromide (CTAB), hexadecyltrimethylammonium chloride (CTAC), tetradecyltrimethylammonium bromide (TTAB), polyvinylpyrrolidone (PVP), polyethylene glycol (PEG), poly(diallyldimethylammonium chloride) (PDDA), Tween 20, oleylamine, and sodium dodecyl sulfate (SDS).

17. A substrate for surface-enhanced Raman scattering comprising:
a substrate; and
the plasmonic nanoframe network particles according to claim 1 arranged on the substrate.

18. The substrate for surface-enhanced Raman scattering according to claim 17, wherein the substrate comprises one or more selected from the group consisting of aluminum, nickel, copper, and iron.
